(19) United States
(12) Patent Application Publication
(10) Pub. No.: US 2012/0200260 A1
(43) Pub. Date: Aug. 9, 2012

(54) SYSTEM FOR ELECTRIC GRID BALANCING AND METHOD OF USING AND PROVIDING THE SAME

(75) Inventors: Donald B. Karner, Phoenix, AZ (US); Kevin P. Morrow, Mesa, AZ (US)

(73) Assignee: Electric Transportation Engineering Corp., dba ECOtality North America, Phoenix, AZ (US)

(21) Appl. No.: 13/442,666

(22) Filed: Apr. 9, 2012

Related U.S. Application Data
(63) Continuation of application No. PCT/US12/29995, filed on Mar. 21, 2012.
Application No. PCT/US12/29995 is a continuation-in-part of application No. PCT/US11/34667, filed on Apr. 29, 2011.
Application No. PCT/US11/34667 is a continuation-in-part of application No. PCT/US11/37587, filed on May 23, 2011.
Application No. PCT/US11/37587 is a continuation-in-part of application No. PCT/US11/37588, filed on May 23, 2011.
Application No. PCT/US11/37588 is a continuation-in-part of application No. PCT/US11/37590, filed on May 23, 2011.
(60) Provisional application No. 61/489,184, filed on May 23, 2011.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.
(60) Provisional application No. 61/367,321, filed on Jul. 23, 2010.
(60) Provisional application No. 61/367,337, filed on Jul. 23, 2010.
(60) Provisional application No. 61/367,317, filed on Jul. 23, 2010.
(60) Provisional application No. 61/367,316, filed on Jul. 23, 2010.

(51) Int. Cl. H02J 7/00; H02J 7/10

(52) U.S. Cl. 320/109; 320/164

(57) ABSTRACT

Some embodiments include systems for electric grid balancing and methods of using and providing the same. Other embodiments of related systems and methods are also disclosed.

### CROSS-REFERENCE TO RELATED APPLICATIONS

This application is a continuation of PCT Application No. PCT/US2012/029995 filed on Mar. 21, 2012, which claims the benefit of U.S. Provisional Application No. 61/489,184, filed May 23, 2011. Further, this application is a continuation-in-part of: (1) PCT Application No. PCT/US2011/034667, filed Apr. 29, 2011; (2) PCT Application No. PCT/US2011/037587, filed May 23, 2011; (3) PCT Application No. PCT/US2011/037588, filed May 23, 2011; and (4) PCT Application No. PCT/US2011/037590, filed May 23, 2011.

PCT Application No. PCT/US2011/034667, PCT Application No. PCT/US2011/037587, PCT Application No. PCT/US2011/037588, and PCT Application No. PCT/US2011/037590 each claim the benefit of: (1) U.S. Provisional Application No. 61/367,316, filed Jul. 23, 2010; (2) U.S. Provisional Application No. 61/367,321, filed Jul. 23, 2010; (3) U.S. Provisional Application No. 61/367,337, filed Jul. 23, 2010; and (4) U.S. Provisional Application No. 61/367,317, filed Jul. 23, 2010. Further, PCT Application No. PCT/US2011/037587, PCT Application No. PCT/US2011/037588, and PCT Application No. PCT/US2011/037590 each are a continuation-in-part of PCT Application No. PCT/US2011/034667.

PCT Application No. PCT/US2012/029995, U.S. Provisional Application No. 61/489,184, PCT Application No. PCT/US2011/034667, PCT Application No. PCT/US2011/037587, PCT Application No. PCT/US2011/037588, PCT Application No. PCT/US2011/037590, U.S. Provisional Application No. 61/367,316, U.S. Provisional Application No. 61/367,321, U.S. Provisional Application No. 61/367,337, and U.S. Provisional Application No. 61/367,317 are each incorporated herein by reference in their entirety.

### STATEMENT REGARDING FEDERALLY SPONSORED RESEARCH OR DEVELOPMENT

This invention was made with U.S. Government support under Contract No. DE-EE00002194 awarded by the Department of Energy. The Government has certain rights in this invention.

### FIELD OF THE INVENTION

This invention relates generally to systems for electric grid balancing, and relates more particularly to such systems for electric grid balancing with electric vehicle charging stations and methods of using and providing the same.

### DESCRIPTION OF THE BACKGROUND

Imbalances in the quantity of electricity being provided to an electric grid and the quantity of electric load imposed on the electric grid can destabilize the electric grid, possibly damaging the electric grid and causing electricity to be unavailable to consumers. Accordingly, electricity suppliers employ electric load balancing to address changes in the electric load on the electricity suppliers' electric grids that result from fluctuating demand for electricity by consumers to ensure that the supply of electricity (e.g., the quantity of electricity provided) and the demand for electricity (e.g., the quantity of electric load imposed) remain as nearly balanced as possible. This electric load balancing can be applied from the standpoint of the supply side (i.e., matching the supply to the demand) as well as the demand side (i.e., matching the demand to the supply).

With respect to the supply side, electricity suppliers conventionally maintain various forms of electricity reserves to conduct electric load balancing, adjusting the supply of electricity to match the demand. One form of electricity reserve, for example, is referred to as the spinning reserve. The spinning reserve represents the sum of any additional generating capacity of electricity available in the presently operating power plants of the respective electric grid. Another form of electricity reserve is the non-spinning reserve, which represents the sum of any additional generating capacity available to the electric grid with a momentary delay. Generally speaking, the non-spinning reserve can be supplied by fast-start electricity generators, but can also be supplied in some cases by other interconnected electric grids. Yet another possible reserve is the replacement reserve which includes any remaining electricity available to the electric grid that requires greater than a momentary delay (e.g., typically 30-60 minutes) to supply. In short, using electricity reserves, electricity suppliers can first adjust the generating output of presently operating generators and then can resort to bringing additional generators online or shutting them down, as necessary.

In addition to electricity reserves, various other electric load balancing techniques are employed or have been proposed for use. For example, one technique includes local load control, which refers to timing and/or regulating the occurrences of duty cycles of any of various electric loads (e.g., appliances, etc.) to the control the electric load on the electric grid. Thus, local load control focuses on the demand side of electric load balancing. Still, a more recently employed electric load balancing technique includes vehicle-to-grid electric load balancing, a form of a broader concept referred to as battery-to-grid electric load balancing in which recharge energy storage systems (e.g., traction batteries for electric vehicles) are used to provide and receive electricity to and from an electric grid to buffer changing electric loads on the electric grid. Thus, vehicle-to-grid electric load balancing essentially provides a hybrid approach to electric load balancing that can be thought of as addressing the supply side and/or the demand side.

Nonetheless, existing techniques for electric load balancing have various disadvantages. For example, maintaining electricity reserves can result in significant expense to electricity suppliers both in terms of operational costs and lost potential sales of electricity. Likewise, electricity reserves can also result in negative environmental impacts as power plants, which are primarily fueled by fossil fuels as opposed to cleaner energy solutions, are constantly operated to maintain the reserve electricity. Meanwhile, local load balancing can require not only consent by consumers to implement, but can also place an undesirable burden on consumers (e.g., requiring consumers to forego using one or more electrically powered devices as desired) and/or can require active involvement by consumers (e.g., requiring consumers to elect which electrically powered devices to forego). Even vehicle-to-grid electric load balancing can result in undesirable wear on the rechargeable energy storage systems (e.g., traction battery chemistries) and decrease the operational life of the rechargeable energy storage systems.

Accordingly, a need or potential for benefit exists for a system of electric load balancing that reduces cost to electricity suppliers and reduces environmental impacts while minimizing the burdens of electric load balancing on consumers.

### BRIEF DESCRIPTION OF THE DRAWINGS

To facilitate further description of the embodiments, the following drawings are provided in which:

FIG. 1 illustrates a system, according to an embodiment;

FIG. 2 illustrates a computer system that is suitable for implementing an embodiment of the system of FIG. 1;

FIG. 3 illustrates a representative block diagram of an example of the elements included in the circuit boards inside chassis of the computer system of FIG. 2;

FIG. 4 illustrates a flow chart for an exemplary method of providing the system of FIG. 1;

FIG. 5 illustrates a flow chart for an exemplary method for operating an electric vehicle charging station, according to an embodiment;

FIG. 6 illustrates a flow chart for an exemplary procedure of adjusting the transfer quantity of electricity being drawn from the at least one electric grid and being provided to the rechargeable energy storage system of the electric vehicle in order to compensate for at least one of a change in or an inadequate value of the total electric voltage and/or the total electric frequency, according to the embodiment of FIG. 5;

FIG. 7 illustrates a flow chart for an exemplary procedure of readjusting the transfer quantity of electricity being drawn from the at least one electric grid and being provided to the rechargeable energy storage system of the electric vehicle in order to provide either (a) that the rechargeable energy storage system of the electric vehicle receives a predetermined charge quantity of electricity or (b) that an average amount of electricity is provided to the rechargeable energy storage system of the electric vehicle over a duration of time, according to the embodiment of FIG. 5;

FIG. 8 illustrates a flow chart for an exemplary method of balancing at least one electric grid, according to an embodiment;

FIG. 9 illustrates a flow chart for an exemplary method of adjusting the transfer quantity of electricity being provided from the at least one electric grid to the electric vehicle charging station in order to compensate for at least one of a change in or an inadequate value of a demand for the total quantity of electricity, according to the embodiment of FIG. 8; and

FIG. 10 illustrates of a flow chart for an exemplary method of readjusting the transfer quantity of electricity being provided from the at least one electric grid to the electric vehicle charging station in order to satisfy a charge request for (a) a sufficient quantity of electricity to provide the rechargeable energy storage system of the electric vehicle with a charge quantity of electricity or (b) an average amount of electricity to be provided to the rechargeable energy storage system of the electric vehicle over a duration of time, according to the embodiment of FIG. 8.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “real time” is defined with respect to operations carried out as soon as practically possible upon occurrence of a triggering event. A triggering event can comprise receipt of data necessary to execute a task or to otherwise process information. Because of delays inherent in transmission and/or in computing speeds, the term “real time” encompasses operations that occur in “near” real time or somewhat delayed from a triggering event.

As used herein, the term “electric grid” follows the conventionally understood definition of the term (e.g., any electrical network configured to deliver electricity from one or more suppliers (e.g., utility companies, etc.) to consumers). Accordingly, the term “electric grid” should be broadly understood to include one or more electrical networks of varying scale. For example, “electric grid” can include an electrical network defined by a geographical area (e.g., one or more continents, countries, states, municipalities, ZIP codes, regions, etc.) and/or defined by some other context (e.g., the electrical network of a local utility company, etc.).

The term “computer network” is defined as a collection of computers and devices interconnected by communications channels that facilitate communications among users and allows users to share resources (e.g., an internet connection, an Ethernet connection, etc.). The computers and devices can be interconnected according to any conventional network topology (e.g., bus, star, tree, linear, ring, mesh, etc.).

### DETAILED DESCRIPTION OF EXAMPLES OF EMBODIMENTS

Some embodiments include a method for operating an electric vehicle charging station. At least part of the method can be implemented via execution of computer instructions configured to run at one or more processing modules and configured to be stored at one or more memory storage modules. The method can comprise: executing one or more first computer instructions configured to draw a transfer quantity of electricity from at least one electric grid with the electric vehicle charging station to provide the transfer quantity of electricity to a rechargeable energy storage system of an electric vehicle, the rechargeable energy storage system being electrically coupled to the electric vehicle charging station, wherein the at least one electric grid comprises a total quantity of electricity, the total quantity of electricity comprises the transfer quantity of electricity, and the total quantity of electricity comprises a grid electric voltage and a grid electric frequency; executing one or more second computer instructions configured to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency; and after executing the one or more second computer instructions, executing one or more third computer instructions configured to readjust the transfer quantity of electricity being drawn from the at least one electric grid and being provided to the rechargeable energy storage system of the electric vehicle in order to provide the rechargeable energy storage system of the electric vehicle with a predetermined charge quantity of electricity. The computer instructions can comprise the one or more first, second, and third computer instructions.

Various embodiments include a method of balancing at least one electric grid. At least part of the method can be implemented via execution of computer instructions configured to run at one or more processing modules and configured to be stored at one or more memory storage modules. The method can comprise: executing one or more first computer instructions configured to provide a transfer quantity of electricity from at least one electric grid to an electric vehicle charging station configured to provide the transfer quantity of electricity to a rechargeable energy storage system of an electric vehicle, the rechargeable energy storage system being electrically coupled to the electric vehicle charging station, wherein the at least one electric grid comprises a total quantity of electricity, and the total quantity of electricity comprises the transfer quantity of electricity; executing one or more second computer instructions configured to adjust the transfer quantity of electricity being provided from the at least one electric grid to the electric vehicle charging station in order to compensate for at least one of a change in or an unsuitable amount of a demand for the total quantity of electricity; and after executing the one or more second computer instructions, executing one or more third computer instructions configured to readjust the transfer quantity of electricity being provided from the at least one electric grid to the electric vehicle charging station in order to satisfy a charge request for a sufficient quantity of electricity to provide the rechargeable energy storage system of the electric vehicle with a charge quantity of electricity. The computer instructions can comprise the one or more first, second, and third computer instructions.

Further embodiments include a system comprising an electric vehicle charging station. The electric vehicle charging station can comprise a charge module and a command module. The charge module can be configured to draw a transfer quantity of electricity from at least one electric grid and to provide the transfer quantity of electricity to a rechargeable energy storage system of an electric vehicle. The rechargeable energy storage system can be configured to be electrically coupled to the electric vehicle charging station. The at least one electric grid can comprise a total quantity of electricity, and the total quantity of electricity can comprise the transfer quantity of electricity. The total quantity of electricity comprises a grid electric voltage and a grid electric frequency. The command module can be configured to instruct the charge module to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency. After instructing the charge module to adjust the transfer quantity of electricity, the command module can be configured to instruct the charge module to readjust the transfer quantity of electricity being drawn from the at least one electric grid and being provided to the rechargeable energy storage system of the electric vehicle in order to provide that the rechargeable energy storage system of the electric vehicle receives a charge quantity of electricity.

Other embodiments include a method of providing a system. The method can comprise: providing a charge module of an electric vehicle charging station, the charge module being configured to draw a transfer quantity of electricity from at least one electric grid and to provide the transfer quantity of electricity to a rechargeable energy storage system of an electric vehicle, the rechargeable energy storage system being configured to electrically couple to the electric vehicle charging station; and providing a command module of the electric vehicle charging station. The at least one electric grid can comprise a total quantity of electricity, the total quantity of electricity can comprise the transfer quantity of electricity, and the total quantity of electricity can comprise a grid electric voltage and a grid electric frequency In many embodiments, the command module can be configured to instruct the charge module to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency. After instructing the charge module to adjust the transfer quantity of electricity, the command module can be configured to instruct the charge module to readjust the transfer quantity of electricity being drawn from the at least one electric grid and being provided to the rechargeable energy storage system of the electric vehicle in order to provide that the rechargeable energy storage system of the electric vehicle receives a charge quantity of electricity.

Still other embodiments include a method for operating an electric vehicle charging station. At least part of the method can be implemented via execution of computer instructions configured to run at one or more processing modules and configured to be stored at one or more memory storage modules. The method can comprise: executing one or more first computer instructions configured to draw a transfer quantity of electricity from at least one electric grid with the electric vehicle charging station to provide the transfer quantity of electricity to a rechargeable energy storage system of an electric vehicle electrically coupled to the electric vehicle charging station, wherein the at least one electric grid comprises a total quantity of electricity, the total quantity of electricity comprises the transfer quantity of electricity, and the total quantity of electricity comprises a grid electric voltage and a grid electric frequency; executing one or more second computer instructions configured to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency; and after executing the one or more second computer instructions, executing one or more third computer instructions configured to readjust the transfer quantity of electricity being drawn from the at least one electric grid and being provided to the rechargeable energy storage system of the electric vehicle, after executing the one or more second instructions, to provide either (a) that the rechargeable energy storage system of the electric vehicle receives a predetermined charge quantity of electricity or (b) that an average amount of electricity is provided to the rechargeable energy storage system of the electric vehicle over a duration of time, wherein the average amount of electricity is the transfer quantity of electricity pursuant to executing the one or more first computer instructions drawn from the at least one electric grid with the electric vehicle charging station. The computer instructions can comprise the one or more first, second, and third computer instructions.

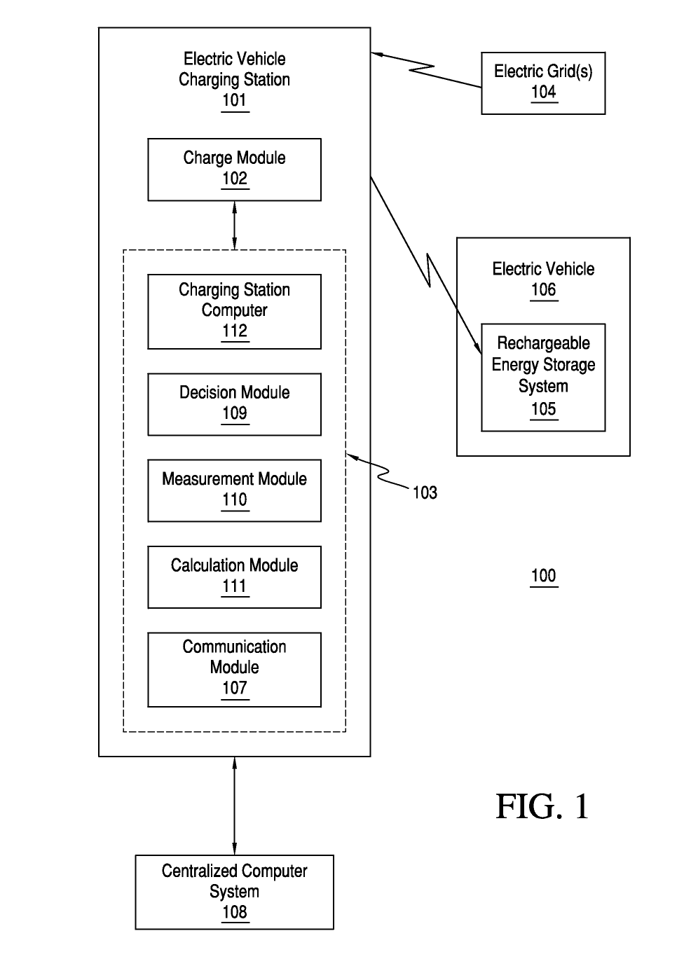

Turning to the drawings, FIG. 1 illustrates system 100, according to an embodiment. System 100 is merely exemplary and is not limited to the embodiments presented herein. System 100 can be employed in many different embodiments or examples not specifically depicted or described herein. In some embodiments, all or part of system 100 can be configured to operate in real time.

System 100 comprises electric vehicle charging station 101, charge module 102, and command module 103. System 100 can also comprise at least one electric grid 104, rechargeable energy storage system 105, electric vehicle 106, centralized computer system 108, and/or charging station computer 112. Further, system 100 can comprise communication module 107, decision module 109, measurement module 110, and/or calculation module 111. In some embodiments, centralized computer system 108 and/or charging station computer 112 can be omitted.

Electric vehicle charging station 101 can comprise charge module 102. Meanwhile, in some embodiments, electric vehicle charging station 101 can also comprise command module 103 (e.g., such that command module 103 can be located at and/or can be part of electric vehicle charging station 101), and in other embodiments, centralized computer system 108 can comprise command module 103 (e.g., in which case command module 103 can be separate from and/or located apart from electric vehicle charging station 101). In many embodiments, electric vehicle 106 can comprise rechargeable energy storage system 105. In some embodiments, electric vehicle charging station 101 and/or command module 103 can comprise charging station computer 112. In many embodiments, command module 103, charging station computer 112, and/or centralized computer system 108 can comprise communication module 107, decision module 109, measurement module 110, and/or calculation module 111.

In many embodiments, command module 103 can be configured to communicate with charge module 102, and/or vice versa, such as, for example, via communication module 107. Further, command module 103, charging station computer 112, and/or centralized computer system 108 can be configured to communicate with each other, as applicable, such as, for example, via communication module 107.

Electric vehicle charging station 101 and/or charge module 102 are configured to be electrically coupled with electric grid(s) 104. In some embodiments, electric grid(s) 104 can comprise multiple electric grids coupled together. The multiple electric grids can have the effect of operating as a single electric grid though comprising multiple electric grids. In many embodiments, electric vehicle charging station 101 and/or charging module 102 can be electrically coupled with electric grid(s) 104.

Charge module 102 is configured to draw electricity (e.g., a transfer quantity of electricity) from electric grid(s) 104 and to provide the electricity (e.g., the transfer quantity of electricity) to rechargeable energy storage system 105 of electric vehicle 106 (e.g., to electrically charge rechargeable energy storage system 105). Rechargeable energy storage system 105 is configured to be electrically coupled to electric vehicle charging station 101, and in some embodiments, rechargeable energy storage system 105 can be electrically coupled to electric vehicle charging station 101. In addition to the transfer quantity of electricity, charge module 102 can also be configured to draw an operational quantity of electricity from electric grid(s) 104 to electrically power electric vehicle charging station 101. Electric vehicle charging station 101 and/or charge module 102 can be configured to draw up to a maximum quantity of electricity (e.g., 6 kilowatts) from electric grid 104. Meanwhile, the transfer quantity can be less than the maximum quantity of electricity and, in many examples, can be approximately half of the maximum quantity of electricity (e.g., 3 kilowatts). By drawing less than the maximum quantity of electricity, electric vehicle charging station 101 and/or charge module 102 can have the flexibility to increase and decrease the transfer quantity of electricity as desired.

Electric grid(s) 104 can comprise a total quantity of electricity (e.g., the sum of all the electricity present in electric grid(s) 104). The total quantity of electricity comprises a total electric voltage (e.g., a grid electric voltage) and a total (i.e., grid) electric frequency (e.g., the average frequency of the total quantity of electricity). The total quantity of electricity can comprise the transfer quantity of electricity and the operational quantity of electricity. Both the transfer quantity of electricity and the operational quantity of electricity each also comprise electric voltages and frequencies. These electric voltages and frequencies can be the same for both the transfer quantity of electricity and the operational quantity of electricity or can be different. Likewise, each can be the same as or different than the total electric voltage and/or total electric frequency, respectively.

Meanwhile, command module 103 is configured to instruct and/or control charge module 102 to adjust the transfer quantity of electricity being drawn from electric grid(s) 104 and being provided to rechargeable energy storage system 105 of electric vehicle 106 in order to compensate for a change in and/or an inadequate value of the total electric voltage and/or the total electric frequency. In many embodiments, it can be desirable that the total electric voltage and/or the total electric frequency remain approximately constant at a predetermined (e.g., adequate and/or suitable) value (e.g., 120 volts (V)±5 percent (%) at 60 Hertz (Hz), 230 voltages±6% at 50 Hz, etc.). For example, the predetermined value can be determined by one or more utility companies operating electric grid(s) 104. Accordingly, the change in the total electric voltage and/or the total electric frequency can indicate the presence of an imbalance in electric grid(s) 104. Specifically, the total electric voltage is approximately directly proportional to the total electric load on electric grid(s) 104, a change in which can thus indicate an increase or decrease in the electricity available from electric grid(s) 104. For example, as an electricity supplier increases or decreases the electricity supplied to the electric grid(s) 104, so too will the total electric voltage increase or decrease, respectively. Likewise, the change in total electric frequency indirectly corresponds to the change in the total electric voltage, and as a result, can also correspond to a change in the demand for the total quantity of electricity. Namely, changes (e.g., imbalances) in the ratio of the supply of and demand for electricity on electric grid(s) 104 create deviations in the total electric frequency of the total quantity of electricity from the frequency at which the total quantity of electricity has been standardized (e.g., 50 Hertz, 60 Hertz, etc.). For example, the frequency of electricity is directly related to the speed of rotation of the electric generators supplying electricity to electric grid(s) 104. A sudden increase in electric load on electric grid(s) 104 can cause slowing in the electric generators supplying electricity to electric grid(s) 104, resulting in measureable deviations in the total electric frequency that are indicative of the increased electric load on electric grid(s) 104, or vice versa. The degree of deviation can thus be correlated to an increase or a decrease in the available electricity in and/or the electric load on electric grid(s) 104.

Importantly, as touched on above, these changes in the total electric voltage and/or the total electric frequency can represent more than imbalances in the total quantity of electricity resulting from applied changes in supply and demand of electricity. For example, in what generally results in a more serious imbalance, a failure or trip of one or more of the electric generators and/or transmission lines, of which electric grid(s) 104 is comprised, can cause excessive load in electric grid(s) 104 that can damage electric grid(s) 104 and potentially knockout part or all of electric grid(s) 104. Therefore, balancing the total electricity can be important not only to buffer applied changes to electric grid(s) 104, but also as a safety guard for electric grid(s) 104.

By adjusting the transfer quantity of electricity being drawn from electric grid(s) 104 and being provided to rechargeable energy storage system 105 of electric vehicle 106, charge module 102 can contribute to balancing electric grid(s) 104 by increasing or decreasing the total electric voltage of electric grid(s) 104. For example, if the supply of electricity in electric grid(s) 104 increases (i.e., the total electric voltage increases), charge module 102 can throttle up the transfer quantity of electricity (e.g., increasing the transfer quantity of electricity from 3 kilowatts to 4 kilowatts) in order to reduce the stress imposed on electric grid(s) 104, or vice versa when the demand for electricity decreases. Thus, contrary to vehicle-to-grid electric load balancing techniques, which also employ electric vehicle charging stations as described above, electric load balancing can be accomplished by system 100 without requiring two-way flow of electricity between rechargeable energy storage system 105 and electric grid(s) 104, sparing wear on rechargeable energy storage system 105. The transfer quantity of electricity can simply be throttled up or down in real time based on the status of electric grid(s) 104 in order to balance the total electric voltage of electric grid(s) 104, thereby reducing or removing the need to resort to operating costly electricity reserves or other less favorable electric load balancing techniques to accomplish the same. Although a single electric vehicle charging station 101 may have only minimal effect on balancing electric grid(s) 104, multiple electric vehicle charging stations comprising electric vehicle charging station 101, when operated cumulatively in coordination with each other, can provide substantial electric load balancing effects. Accordingly, in many embodiments, the operations of the multiple electric vehicle charging stations can be coordinated together by a central computer system such as centralized computer system 108, as described below. Meanwhile, by coordinating the multiple electric vehicle charging stations comprising electric vehicle charging station 101, the electric load balancing can be spread out across electric grid(s) 104 such that the electric load balancing balances electric grid(s) 104 more proportionately throughout, thereby mitigating and/or preventing localized issues.

In various embodiments, command module 103 can be configured to instruct and/or control charge module 102 to adjust the transfer quantity of electricity being drawn from electric grid(s) 104 and being provided to rechargeable energy storage system 105 of electric vehicle 106 in order to compensate for at least one of a change in or an inadequate value of the total electric voltage and/or the total electric frequency when the total electric voltage and/or the total electric frequency vary when an existing value of the total electric voltage and/or the total electric frequency varies from the predetermined value of the total electric voltage and/or total electric frequency by a predetermined difference (e.g., ±1%, ±2%±5%, ±6%±10%, and/or ±15%, etc.).

In some embodiments, electricity suppliers can provide discounts and/or other incentives to consumers in exchange for helping the electricity suppliers to balance the total electric voltage of electric grid(s) 104 (e.g., when consumers agree to contribute their respective electric vehicle charging station 101 and/or rechargeable energy storage system 105 to balancing electric grid(s) 104). In other embodiments, electricity suppliers can provide the discounts and/or other incentives to third-parties operating one or more electric vehicle charging stations (e.g., electric vehicle charging station 101). The third-parties can pass some or all of the discounts and/or incentives on to the consumers in these embodiments.

Electric vehicle 106 can comprise one of a car, a truck, a motorcycle, a bicycle, a scooter, a boat, a train, an aircraft, an airport ground support equipment, a material handling equipment (e.g., a fork-lift), etc. In the same or different embodiments, electric vehicle 106 can comprise one of a full electric vehicle or any other grid-connected vehicle. Electric vehicle 106 can be configured for low speeds and/or high speeds. Although system 100 can be employed where charging any electric vehicle 106, because the electric load balancing capabilities of system 100 can depend largely on the number of electric vehicle charging stations of which system 100 is comprised, system 100 can be particularly effective when employed with fleet vehicle applications (e.g., commercial and/or industrial operations). For example, warehouses can provide an ideal environment in which to employ system 100 while charging various work vehicles (e.g., forklifts, material handling equipment, electric ground support equipment, etc.).

After instructing and/or controlling charge module 102 to adjust the transfer quantity of electricity, command module 103 is configured to instruct and/or control charge module 102 to readjust the transfer quantity of electricity being drawn from electric grid(s) 104 and being provided to rechargeable energy storage system 105 of electric vehicle 106 in order to provide that rechargeable energy storage system 105 of electric vehicle 106 receives a charge quantity of electricity, or in some embodiments, that an average amount of electricity is provided to rechargeable energy storage system 105 of electric vehicle 106 over a duration of time. The charge quantity of electricity can comprise a desired and/or predetermined quantity of electricity (e.g., a specified quantity of kilowatt-hours, a specified percentage of the total kilowatt-hour capacity of rechargeable energy storage system 105, etc.) to be provided to rechargeable energy storage system 105 by electric vehicle charging station 101 and/or charge module 102. The average amount of electricity can be the transfer quantity of electricity (e.g., 3 kilowatts) before charge module 102 adjusts the transfer quantity of electricity (e.g., increases the 3 kilowatt charge to 4 kilowatts).

How command module 103 instructs and/or controls charge module 102 to readjust the transfer quantity of electricity can depend on the mode of charging by which electric vehicle charging station 101 and/or charge module 102 is presently charging rechargeable energy storage system 105. For example, if a user desires rechargeable energy storage system 105 to be charged to a particular level such that the user provides a charge request to electric vehicle charging station 101 to charge rechargeable energy storage system 105 to the charge quantity of electricity, command module 103 will instruct and/or control charge module 102 such that the charge quantity of electricity is provided. On the other hand, if the user desires that electric vehicle charging station 101 simply provide a particular quantity (e.g., 3 kilowatts) of electricity (e.g., the transfer quantity of electricity) to charge rechargeable energy storage system 105 for a particular duration of time (e.g., an hour, two hours, etc.) and thus provides a charge request therefor, command module 103 will instruct and/or control charge module 102 pursuant to maintaining that the average charge provided to rechargeable energy storage system 105 during that time approximately equals the particular quantity of electricity.

Accordingly, command module 103 and/or centralized computer system 108 can be configured to receive a charge request from a user of system 100. In those embodiments where centralized computer system 108 receives the charge request, but centralized computer system 108 does not comprise command module 103 (e.g., electric vehicle charging station 101 comprises command module 103), command module 103 can be configured to communicate with centralized computer system 108 to receive the charge request and/or to receive instructions on how to instruct and/or control charge module 102 based on the charge request.

Returning back to the subject of command module 103 instructing and/or controlling charge module 102 to readjust the transfer quantity of electricity being drawn from electric grid(s) 104, although on the one hand, system 100 can be utilized for balancing the total electric voltage of electric grid(s) 104, it is not necessarily desirable to do so at the expense of inadequately and/or undesirably charging rechargeable energy storage system 105. Still, in many examples, it can be possible to: (a) adjust the transfer quantity of electricity to balance the total electric voltage during some intervals of time; and (b) readjust the transfer quantity of electricity during other intervals of time to ultimately achieve an adequate and/or desirable charge for rechargeable energy storage system 105. Accordingly, it can be appreciated that system 100 can operate to actively and/or continuously adjust/readjust the transfer quantity of electricity in real time, as applicable, during the course of electric vehicle charging station 101 operating to charge rechargeable energy storage system 105. Further, it can be appreciated that adjusting and readjusting the transfer quantity of electricity need not necessarily occur in succession. For example, charge module 102 may adjust the transfer quantity of electricity one or more times in a row for electric load balancing purposes and then successively readjust the transfer quantity of electricity one or more times in a row for charging purposes, or vice versa.

In many embodiments, electric vehicle charging station 101 can comprise electric vehicle supply equipment. Electric vehicle supply equipment can comprise a device for providing electricity to rechargeable energy storage system 105 (e.g., electrically charging rechargeable energy storage system 105 via charge module 102) of electric vehicle 106 and/or receiving electricity from rechargeable energy storage system 105 of electric vehicle 106. In other embodiments, electric vehicle charging station 101 can comprise an industrial electric charger (e.g., an on-board AC electric charger, a off-board DC electric charger). In still other embodiments, electric vehicle charging station 101 can be configured to transfer electricity to rechargeable energy storage system 105 of the at least one electric vehicle via electrical induction. Electric vehicle charging station 101 can comprise either of a stand-alone unit or a wall-mounted unit.

The electric vehicle supply equipment can comprise any suitable alternating current and/or direct current electric vehicle supply equipment. For example, multiple electricity transfer systems 101 can comprise electric vehicle supply equipment configured according to any one of the Society of Automotive Engineers (SAE) International electric vehicle supply equipment standards (e.g., Level 1, Level 2, and/or Level 3) and/or the International Electrotechnical Commission (IEC) standards (e.g., Mode 1, Mode 2, Mode 3, and/or Mode 4). In some embodiments, the Level 2 electric vehicle supply equipment and/or the Level 3 electric vehicle supply equipment can also be referred to as a fast charger. In many embodiments, the electric vehicle supply equipment can make available electricity comprising a maximum electric current of 30 amperes (A) or 48 A. When the maximum electric current of the electric vehicle supply equipment comprises 30 A, the electric vehicle supply equipment can be configured to make available electricity comprising an electric current of one or more of 12 A, 16 A, or 24 A. When the maximum electric current of the electric vehicle supply equipment comprises 48 A, the electric vehicle supply equipment can be configured to make available electricity comprising an electric current of one or more of 12 A, 16 A, 24 A, or 30 A.

In some examples, Level 1 AC electric vehicle supply equipment can make available electricity comprising an electric voltage of approximately 120 volts (V) and an electric current: (a) greater than or equal to approximately 0 amperes (A) and less than or equal to approximately 12 A AC, when employing a 15 A breaker, or (b) greater than or equal to approximately 0 A and less than or equal to approximately 16 A AC, when employing a 20 A breaker. Accordingly, Level 1 electric vehicle supply equipment can comprise a standard grounded domestic electrical outlet. Meanwhile, Level 2 AC electric vehicle supply equipment can make available electricity comprising an electric voltage greater than or equal to approximately 208 and less than or equal to approximately 240 V and an electric current greater than or equal to approximately 0 A and less than or equal to approximately 80 A AC. Furthermore, Level 3 electric vehicle supply equipment can make available electricity comprising an electric voltage greater than or equal to approximately 208 and an electric current greater than or equal to approximately 80 A AC (e.g., 240 AC (single phase), 208 V AC (triple phase), 480 V AC (triple phase). In some embodiments, the electric voltages for Level 1 electric vehicle supply equipment, Level 2 electric vehicle supply equipment, and/or Level 3 electric vehicle supply equipment can be within plus or minus (±) ten percent (%) tolerances of the electric voltages provided above.

In other examples, Level 1 DC electric vehicle supply equipment can provide electric power greater than or equal to approximately 0 kiloWatts (kW) and less than or equal to approximately 19 kW. Meanwhile, Level 2 DC electric vehicle supply equipment can provide electric power greater than or equal to approximately 19 kW and less than or equal to approximately 90 kW. Furthermore, Level 3 electric vehicle supply equipment can provide electric power greater than or equal to approximately 90 kW. In some embodiments, the term fast charger can refer to an electric vehicle supply equipment providing electricity comprising an electric voltage between approximately 300 V-500 V and an electric current between approximately 100 A-400 A DC.

The industrial electric charger (e.g., the on-board AC electric charger, the off-board DC electric charger) can provide electric power greater than or equal to approximately 3 kW and less than or equal to approximately 33 kW. The off-board DC electric charger can provide electricity comprising an electric voltage greater than or equal to approximately 18 V DC and less than or equal to approximately 120 V DC.

Rechargeable energy storage system 105 can be configured to provide electricity to electric vehicle 106 to provide motive (e.g., traction) electrical power to electric vehicle 106 and/or to provide electricity to any electrically operated components of electric vehicle 106. In specific examples, rechargeable energy storage system 105 can comprise (a) one or more batteries and/or one or more fuel cells, (b) one or more capacitive energy storage systems (e.g., super capacitors such as electric double-layer capacitors), and/or (c) one or more inertial energy storage systems (e.g., one or more flywheels). In many embodiments, the one or more batteries can comprise one or more rechargeable and/or non-rechargeable batteries. For example, the one or more batteries can comprise one or more lead-acid batteries, valve regulated lead acid (VRLA) batteries such as gel batteries and/or absorbed glass mat (AGM) batteries, nickel-cadmium (NiCd) batteries, nickel-zinc (NiZn) batteries, nickel metal hydride (NiMH) batteries, zebra (e.g., molten chloroaluminate (NaAlCl₄)) batteries, and/or lithium (e.g., lithium-ion (Li-ion)) batteries. In some embodiments, where recharge energy storage system 105 comprises multiple batteries, the batteries can all comprise the same type of battery or can comprise multiple types of batteries. Meanwhile, in various embodiments, the fuel cell(s) can comprise at least one hydrogen fuel cell.

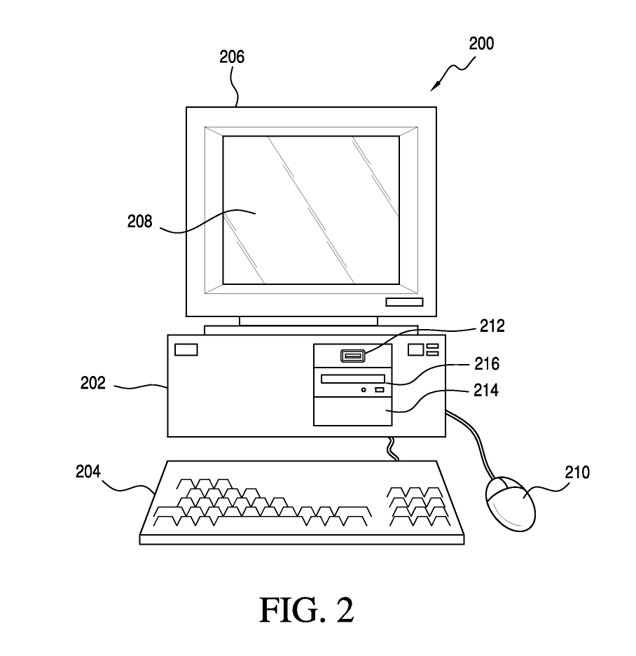

Charging station computer 112 can be suitable and/or configured for implementing (a) command module 103 (e.g., when electric vehicle charging station 101 comprises command module 103) and/or (b) one or more of decision module 109, measurement module 110, calculation module 111, and/or communication module 107, as described in further detail below. In various examples, charging station computer 112 can be similar or identical to computer system 200 (FIG. 2). Further, in some embodiments, some or all of the functionality of charging station computer 112 can alternatively or additionally be implemented as a charging station application programmable interface (e.g., via cloud computing). As an example, the charging station application programmable interface can communicate (e.g., via communication module 107) with one or more cloud computer systems, and can be operated (e.g., in the capacity of an interface only) at one or more processors and/or stored at one or more memory storage modules of charging station computer 112 while the remaining functional aspects of charging station computer 112, as described herein, are operable at one or more processors and/or storable at one or more memory storage modules of the cloud computer system(s). Accordingly, the cloud computer system(s) can each also be similar or identical to computer system 200 (FIG. 2). For convenience of illustration, charging station computer 112 is generally described herein with respect to charging station computer 112 only, but in many embodiments, reference to charging station computer 112 can mean charging station computer 112 and/or the charging station application programmable interface.

Centralized computer system 108 can be suitable and/or configured for implementing (a) command module 103 (e.g., when centralized computer system 108 comprises command module 103) and/or (b) one or more of decision module 109, measurement module 110, calculation module 111, and/or communication module 107, as described in further detail below. Similar to charging station computer system 112, centralized computer system 108 can be similar or identical to computer system 200 (FIG. 2). Further, in some embodiments, some or all of the functionality of centralized computer system 108 can alternatively or additionally be implemented as a centralized application programmable interface (e.g., via cloud computing). As an example, the centralized application programmable interface can communicate (e.g., via communication module 107) with the cloud computer system(s), and can be operated (e.g., in the capacity of an interface only) at one or more processors and/or stored at one or more memory storage modules of centralized computer system 108 while the remaining functional aspects of centralized computer system 108, as described herein, are operable at one or more processors and/or storable at one or more memory storage modules of the cloud computer system(s). As for charging station computer 112, for convenience of illustration, centralized computer system 108 is generally described herein with respect to centralized computer system 108 only, but in many embodiments, reference to centralized computer system 108 can mean centralized computer system 108 and/or the centralized application programmable interface. In general, centralized computer system 108 can be located remotely from electric vehicle charging station 101, and/or can be configured to communicate (e.g., via communication module 107) with electric vehicle charging station 101 and/or command module 103.

Communication module 107, decision module 109, measurement module 110, and/or calculation module 111 can be implemented to permit and/or support command module 103, charging station computer 112, and/or centralized computer system 108, as applicable, to balance the total electric voltage of electric grid(s) 104 and/or to charge rechargeable energy storage system 105, as described above. Accordingly, communication module 107, decision module 109, measurement module 110, and/or calculation module 111 can be configured to operate in real time.

Communication module 107 can be configured to receive and/or solicit one or more balance requests to compensate for the change in and/or the inadequate value of the total electric voltage and/or the total electric frequency and to communicate the request to command module 103. In some embodiments, communication module 107 can be configured to receive a measurement of the change in the total electric voltage and/or the total electric frequency and to communicate the measurement to command module 103. Communication module 107 can comprise at least one computer network connection and/or at least one telephone network connection to permit communication module 107 to receive the balance request(s). In various embodiments, communication module 107 can receive and/or solicit the balance request(s) from one or more electricity suppliers (e.g., utility companies), as mentioned above. Meanwhile, in some embodiments, communication module 107 can receive the measurement of the change in the total electric voltage and/or the total electric frequency from the electricity supplier(s) and/or from measurement module 110, as described below.

Measurement module 110 can be configured to measure the change in the total electric voltage and/or the total electric frequency. In various embodiments, measurement module 110 can measure the change in the total electric voltage and/or the total electric frequency in response to communication module 107 receiving the balance request. In other embodiments, measurement module 110 can measure the change in the total electric voltage and/or the total electric frequency to notify communication module 107 to solicit the balance request, and in some examples, the electricity supplier(s) can confirm the solicited balance request. Measurement module 110 can provide any measured change in the total electric voltage and/or the total electric frequency to decision module 109 and/or calculation module 111 to permit decision module 109 and/or calculation module 111 to perform their respective functions.

Decision module 109 can be configured to determine whether charge module 102 is able to adjust the transfer quantity of electricity (a) being drawn from the at least one electric grid 104 and (b) being provided to rechargeable energy storage system 105 of electric vehicle 106, in order to compensate for at least one of the change in or the inadequate value of the total electric voltage and/or the total electric frequency while remaining able to readjust the transfer quantity of electricity (y) being drawn from the at least one electric grid 104 and (z) being provided to rechargeable energy storage system 105 of electric vehicle 106, in order to provide that rechargeable energy storage system 105 of electric vehicle 106 receives the charge quantity of electricity and/or that the average amount of electricity is provided to rechargeable energy storage system 105 of electric vehicle 106 over the duration of time, as applicable. Accordingly, decision module 109 can operate as a logic faculty of command module 103, determining whether charge module 102 has the present capacity to balance the total electric voltage of electric grid 104 and making the decision as to how to instruct and/or control charge module 102 for command module 103. Decision module 109 can operate in conjunction with calculation module 111, which can provide quantitative data to decision module 109 upon which decision module 109 can base its determinations.

More specifically, calculation module 111 can be configured to: (a) calculate a first amount of electricity by which to adjust the transfer quantity of electricity (i) being drawn from the at least one electric grid 104 and (ii) being provided to rechargeable energy storage system 105 of electric vehicle 106, in order to compensate for the at least one of the change in or the inadequate value of the total electric voltage and/or the total electric frequency and/or (b) after command module 103 instructs charge module 102 (or simultaneously with calculating the first amount of electricity) to adjust the transfer quantity of electricity, calculate a second amount of electricity by which to readjust the transfer quantity of electricity (i) being drawn from the at least one electric grid 104 and (ii) being provided to rechargeable energy storage system 105 of electric vehicle 106, in order to provide that rechargeable energy storage system 105 of electric vehicle 106 receives the charge quantity of electricity.

As introduced briefly above, centralized computer system 108 can be configured to coordinate one or more electric vehicle charging stations comprising electric vehicle charging station 101 to balance the total electric voltage of electric grid 104 while charging multiple rechargeable energy storage systems comprising rechargeable energy storage system 105. Accordingly, in some examples, centralized computer system 108 can comprise one command module 103 in communication with one charge module at each of the multiple electric vehicle charging stations. In other examples, each of the multiple electric vehicle charging stations can comprise its own respective command module 103 and centralized computer system 108 can communicate and/or control each command module 103. In any of these examples, the electric vehicle charging stations can communicate with each other and the centralized computer system, or can communicate with the centralized computer system but not with each other.

In still other examples, system 100 may not comprise centralized computer system 108, or system 100 can comprise centralized computer system 108, but merely for purposes of administrating communication between centralized computer system 108 and each command module 103 and/or intercommunication between each command module 103. In the same or different examples, each command module 103 can independently control its respective electric vehicle charging station (e.g., electric vehicle charging station 101) and/or can communicate and coordinate among each other to control the multiple electric vehicle charging stations aggregately.

In various embodiments, command module 103 and/or centralized computer system 108 can be configured to receive one or more balance requests to compensate for the at least one of the change in or the inadequate value of the change in the total electric voltage and/or the total electric frequency, such as from electricity suppliers. In these embodiments, command module 103 and/or centralized computer system 108 can comprise communication module 107, as described below, to receive the one or more balance requests. Alternatively and/or concurrently, command module 103 and/or centralized computer system 108 can determine independently (e.g., without requiring active involvement by electricity suppliers) whether to compensate for the at least one of the change in or the inadequate value of the total electric voltage and/or the total electric frequency. In these embodiments, command module 103 and/or centralized computer system 108 can comprise measurement module 110 to measure changes in the total electric voltage and/or the total electric frequency, as described below.

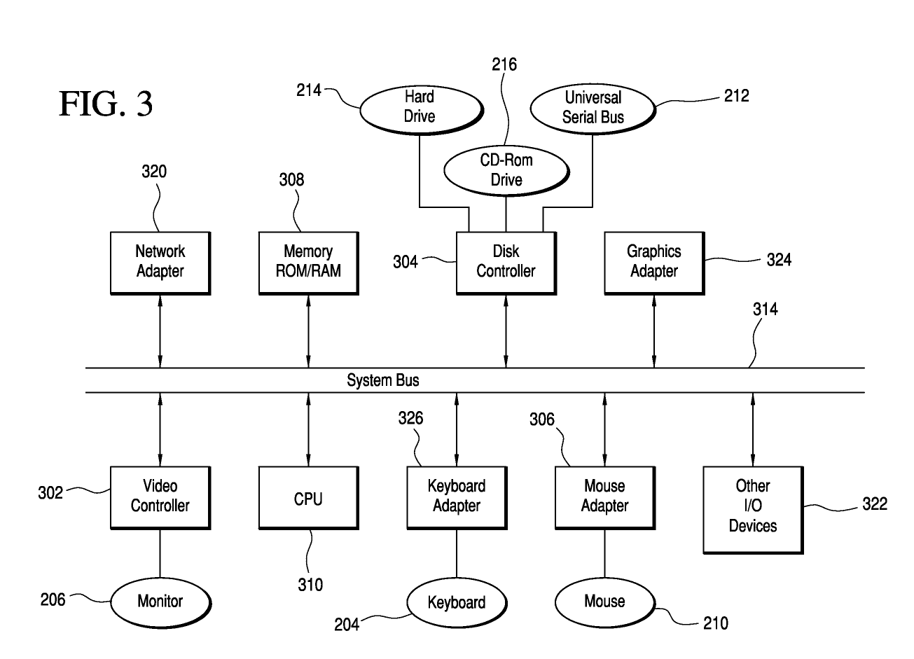

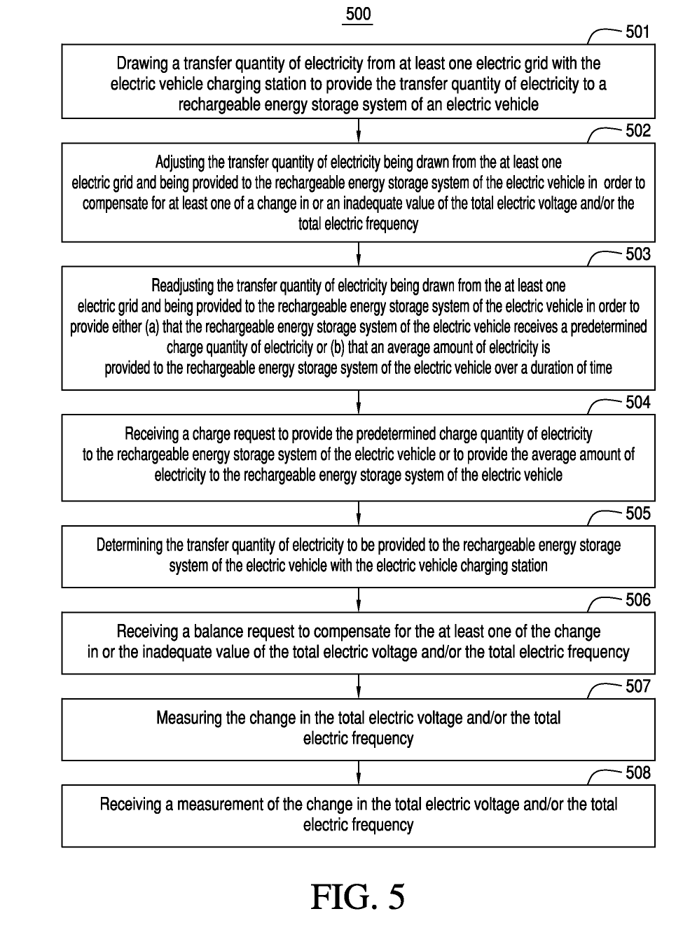

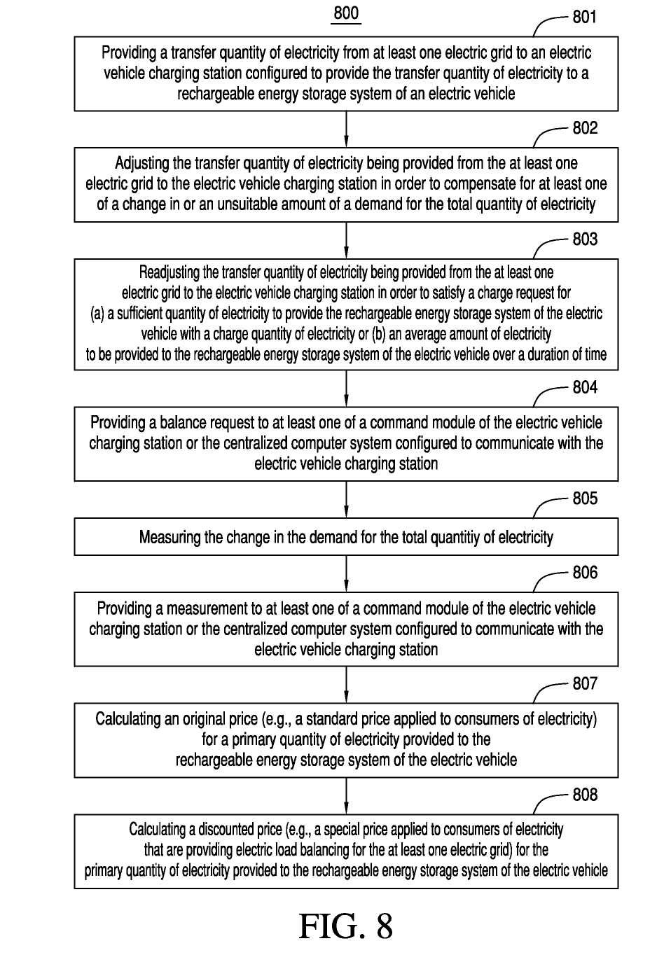

Turning to the next drawing, FIG. 2 illustrates an exemplary embodiment of computer system 200 that can be suitable for implementing an embodiment of charging station computer 112 (FIG. 1), centralized computer system 108 (FIG. 1), the cloud computer system(s) referenced with respect to system 100 (FIG. 1), and/or at least part of system 100 (FIG. 1), method 500 (FIG. 5), and/or method 800 (FIG. 8). As an example, a different or separate one of chassis 202 (and its internal components) can be suitable for implementing charging station computer 112 (FIG. 1), centralized computer system 108 (FIG. 1), etc. Furthermore, one or more elements of computer system 200 (e.g., refreshing monitor 206, keyboard 204, and/or mouse 210, etc.) can also be appropriate for implementing centralized computer system 108 (FIG. 1). Computer system 200 includes chassis 202 containing one or more circuit boards (not shown), Universal Serial Bus (USB) 212, Compact Disc Read-Only Memory (CD-ROM) and/or Digital Video Disc (DVD) drive 216, and hard drive 214. A representative block diagram of the elements included on the circuit boards inside chassis 202 is shown in FIG. 3. Central processing unit (CPU) 310 in FIG. 3 is coupled to system bus 314 in FIG. 3. In various embodiments, the architecture of CPU 310 can be compliant with any of a variety of commercially distributed architecture families.

Continuing with FIG. 3, system bus 314 also is coupled to memory storage unit 308, where memory storage unit 308 comprises both read only memory (ROM) and random access memory (RAM). Non-volatile portions of memory storage unit 308 or the ROM can be encoded with a boot code sequence suitable for restoring computer system 200 (FIG. 2) to a functional state after a system reset. In addition, memory storage unit 308 can comprise microcode such as a Basic Input-Output System (BIOS). In some examples, the one or more memory storage units of the various embodiments disclosed herein can comprise memory storage unit 308, a USB-equipped electronic device, such as, an external memory storage unit (not shown) coupled to universal serial bus (USB) port 212 (FIGS. 2-3), hard drive 214 (FIGS. 2-3), and/or CD-ROM or DVD drive 216 (FIGS. 2-3). In the same or different examples, the one or more memory storage units of the various embodiments disclosed herein can comprise an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Examples of common operating systems can include Microsoft® Windows, Mac® operating system (OS), UNIX® OS, and Linux® OS. Where computer system 200 is implemented as a mobile computer device (e.g., a smart phone, a tablet computer system, etc.), common operating systems for a mobile electronic device include the iPhone® operating system by Apple Inc. of Cupertino, Calif., the Blackberry® operating system by Research In Motion (RIM) of Waterloo, Ontario, Canada, the Palm® operating system by Palm, Inc. of Sunnyvale, Calif., the Android operating system developed by the Open Handset Alliance, the Windows Mobile operating system by Microsoft Corp. of Redmond, Wash., or the Symbian operating system by Nokia Corp. of Espoo, Finland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions.

In the depicted embodiment of FIG. 3, various I/O devices such as disk controller 304, graphics adapter 324, video controller 302, keyboard adapter 326, mouse adapter 306, network adapter 320, and other I/O devices 322 can be coupled to system bus 314. Keyboard adapter 326 and mouse adapter 306 are coupled to keyboard 204 (FIGS. 2-3) and mouse 210 (FIGS. 2-3), respectively, of computer system 200 (FIG. 2). While graphics adapter 324 and video controller 302 are indicated as distinct units in FIG. 3, video controller 302 can be integrated into graphics adapter 324, or vice versa in other embodiments. Video controller 302 is suitable for refreshing monitor 206 (FIGS. 2-3) to display images on a screen 208 (FIG. 2) of computer system 200 (FIG. 2). Disk controller 304 can control hard drive 214 (FIGS. 2-3), USB port 212 (FIGS. 2-3), and CD-ROM drive 216 (FIGS. 2-3). In other embodiments, distinct units can be used to control each of these devices separately.

In some embodiments, network adapter 320 can comprise and/or be implemented as a WNIC (wireless network interface controller) card (not shown) plugged or coupled to an expansion port (not shown) in computer system 200 (FIG. 2). In other embodiments, the WNIC card can be a wireless network card built into computer system 200 (FIG. 2). A wireless network adapter can be built into computer system 200 by having wireless communication capabilities integrated into the motherboard chipset (not shown), or implemented via one or more dedicated wireless communication chips (not shown), connected through a PCI (peripheral component interconnector) or a PCI express bus of computer system 200 (FIG. 2) or USB port 212 (FIG. 2). In other embodiments, network adapter 1320 can comprise and/or be implemented as a wired network interface controller card (not shown). Accordingly, communication module 107 (FIG. 1) can comprise a network adapter similar or identical to network adapter 1320.

Although many other components of computer system 200 (FIG. 2) are not shown, such components and their interconnection are well known to those of ordinary skill in the art. Accordingly, further details concerning the construction and composition of computer system 200 and the circuit boards inside chassis 202 (FIG. 2) are not discussed herein.

When computer system 200 in FIG. 2 is running, program instructions stored on a USB-equipped electronic device connected to USB port 212, on a CD-ROM or DVD in CD-ROM and/or DVD drive 216, on hard drive 214, or in memory storage unit 308 (FIG. 3) are executed by CPU 310 (FIG. 3). A portion of the program instructions, stored on these devices, can be suitable for carrying out at least part of method 500, and/or method 800 (FIGS. 5 & 8) and implementing one or more components of system 100 (FIG. 1).

Although computer system 200 is illustrated as a desktop computer in FIG. 2, as indicated above, there can be examples where computer system 200 may take a different form factor while still having functional elements similar to those described for computer system 200. In some embodiments, computer system 200 may comprise a single computer, a single server, or a cluster or collection of computers or servers, or a cloud of computers or servers. Typically, a cluster or collection of servers can be used when the demand on computer system 200 exceeds the reasonable capability of a single server or computer, such as, for example, for centralized computer system 108 (FIG. 1). In many embodiments, the servers in the cluster or collection of servers are interchangeable from the perspective of command module 103 and/or charging station computer 112.

Meanwhile, in some embodiments, centralized computer system 108 (FIG. 1) and/or charging station computer 112 (FIG. 1) can have only those processing capabilities and/or memory storage capabilities as are reasonably necessary to perform the functionality, described above with respect to system 100 (FIG. 1). In a more detailed example, charging station computer 112 (FIG. 1) could be implemented as a microcontroller comprising flash memory, or the like. Reducing the sophistication and/or complexity of centralized computer system 108 (FIG. 1) and/or charging station computer 112 (FIG. 1) can reduce the size and/or cost of implementing system 100 (FIG. 1). Nonetheless, in other embodiments, centralized computer system 108 (FIG. 1) and/or charging station computer 112 (FIG. 1) may need additional sophistication and/or complexity to operate as desired.

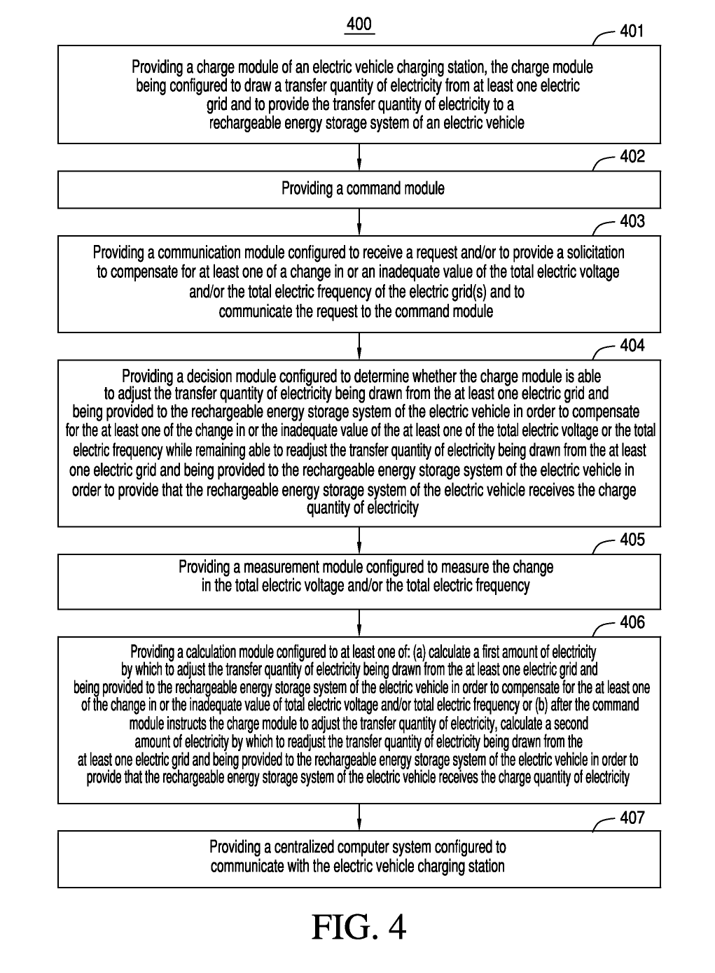

Turning ahead again in the drawings, FIG. 4 illustrates a flow chart for an embodiment of method 400 of providing a system. Method 400 is merely exemplary and is not limited to the embodiments presented herein. Method 400 can be employed in many different embodiments or examples not specifically depicted or described herein. In some embodiments, the procedures, the processes, and/or the activities of method 400 can be performed in the order presented. In other embodiments, the procedures, the processes, and/or the activities of method 400 can be performed in any other suitable order. In still other embodiments, one or more of the procedures, the processes, and/or the activities in method 400 can be combined or skipped.

Referring now to FIG. 4, method 400 comprises procedure 401 of providing a charge module of an electric vehicle charging station, the charge module being configured to draw a transfer quantity of electricity from at least one electric grid and to provide the transfer quantity of electricity to a rechargeable energy storage system of an electric vehicle. The charge module can be similar or identical to charge module 102 (FIG. 1), the electric vehicle charging station can be similar or identical to electric vehicle charging station 101 (FIG. 1), the rechargeable energy storage system can be similar or identical to rechargeable energy storage system 105 (FIG. 1), and/or the electric vehicle can be similar or identical to electric vehicle 106 (FIG. 1).

Referring again to FIG. 4, method 400 comprises procedure 402 of providing a command module. The command module can be similar or identical to command module 103 (FIG. 1). In some embodiments, procedure 402 can be performed as part of procedure 407, as described below.

Referring again to FIG. 4, method 400 can comprise procedure 403 of providing a communication module configured to receive a request and/or to provide a solicitation to compensate for at least one of a change in or an inadequate value of the total electric voltage and/or the total electric frequency of the electric grid(s) and to communicate the request to the command module. In some embodiments, procedure 403 can be performed as part of procedure 402 or procedure 407, as described below. The communication module can be similar or identical to communication module 107 (FIG. 1).

Referring again to FIG. 4, method 400 can comprise procedure 404 of providing a decision module configured to determine whether the charge module is able to adjust the transfer quantity of electricity being drawn from the at least one electric grid and being provided to the rechargeable energy storage system of the electric vehicle in order to compensate for the at least one of the change in or the inadequate value of in the at least one of the total electric voltage or the total electric frequency while remaining able to readjust the transfer quantity of electricity being drawn from the at least one electric grid and being provided to the rechargeable energy storage system of the electric vehicle in order to provide that the rechargeable energy storage system of the electric vehicle receives the charge quantity of electricity. In some embodiments, procedure 404 can be performed as part of procedure 402 or procedure 407, as described below. The decision module can be similar or identical to decision module 109 (FIG. 1).

Referring again to FIG. 4, method 400 can comprise procedure 405 of providing a measurement module configured to measure the change in the total electric voltage and/or the total electric frequency. In some embodiments, procedure 405 can be performed as part of procedure 402 or procedure 407, as described below. The measurement module can be similar or identical to measurement module 110 (FIG. 1).

Referring again to FIG. 4, method 400 can comprise procedure 406 of providing a calculation module configured to at least one of: (a) calculate a first amount of electricity by which to adjust the transfer quantity of electricity being drawn from the at least one electric grid and being provided to the rechargeable energy storage system of the electric vehicle in order to compensate for the at least one of the change in or the inadequate value of the total electric voltage and/or the total electric frequency or (b) after the command module instructs the charge module to adjust the transfer quantity of electricity, calculate a second amount of electricity by which to readjust the transfer quantity of electricity being drawn from the at least one electric grid and being provided to the rechargeable energy storage system of the electric vehicle in order to provide that the rechargeable energy storage system of the electric vehicle receives the charge quantity of electricity. In some embodiments, procedure 406 can be performed as part of procedure 402 or procedure 407, as described below. The calculation module can be similar or identical to calculation module 111 (FIG. 1).

Referring again to FIG. 4, method 400 can comprise procedure 407 of providing a centralized computer system configured to communicate with the electric vehicle charging station. The centralized computer system can be similar or identical to centralized computer system 108 (FIG. 1).

In some embodiments, performing any of procedures 401-406 can be performed by providing the electric vehicle charging station.

FIG. 5 illustrates a flow chart for an embodiment of method 500 for operating an electric vehicle charging station. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any other suitable order. In still other embodiments, one or more of the procedures, the processes, and/or the activities in method 500 can be combined or skipped. In some embodiments, all or part of method 500 can be configured to operate in real time.

Referring now to FIG. 5, method 500 comprises procedure 501 of drawing a transfer quantity of electricity from at least one electric grid with the electric vehicle charging station to provide the transfer quantity of electricity to a rechargeable energy storage system of an electric vehicle. Performing procedure 501 can be similar or identical to drawing the transfer quantity of electricity from electric grid 104 (FIG. 1) with electric vehicle charging station 101 (FIG. 1) and/or charge module 102 (FIG. 1) and providing the transfer quantity of electricity to rechargeable energy storage system 105 (FIG. 1) of electric vehicle 106 (FIG. 1), as described above with respect to system 100 (FIG. 1). Accordingly, the at least one electric grid can be similar or identical to electric grid 104 (FIG. 1), the electric vehicle charging station can be similar or identical to electric vehicle charging station 101 (FIG. 1), the rechargeable energy storage system can be similar or identical to rechargeable energy storage system 105 (FIG. 1), and/or the electric vehicle can be similar or identical to electric vehicle 106 (FIG. 1).

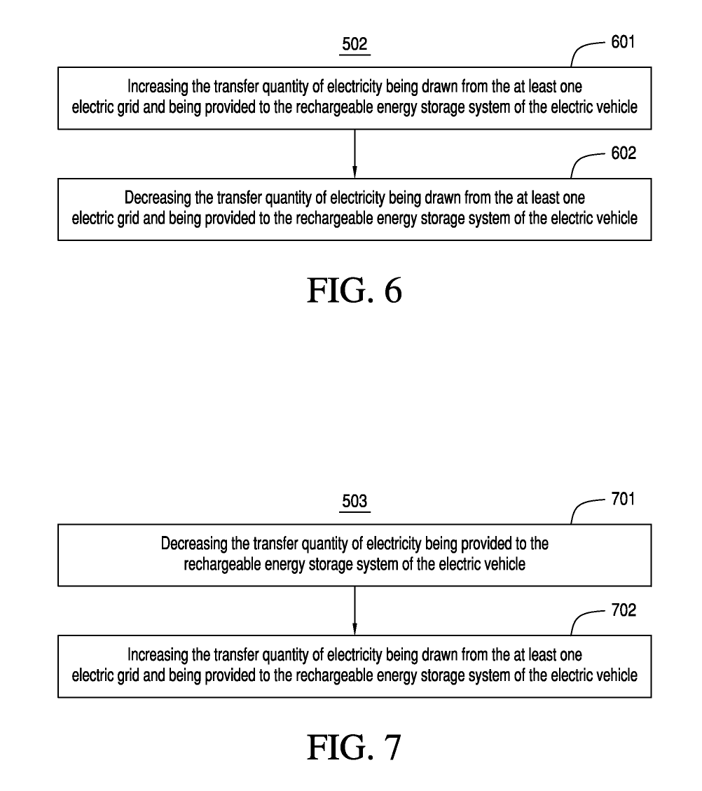

Referring again to FIG. 5, method 500 comprises procedure 502 of adjusting the transfer quantity of electricity being drawn from the at least one electric grid and being provided to the rechargeable energy storage system of the electric vehicle in order to compensate for at least one of a change in or an inadequate value of the total electric voltage and/or the total electric frequency. In some embodiments, procedure 502 can comprise adjusting the transfer quantity of electricity being drawn from the at least one electric grid and being provided to the rechargeable energy storage system of the electric vehicle in order to compensate for the at least one of a change in or an unsuitable amount of a demand for the total quantity of electricity. Performing procedure 502 can be similar or identical to adjusting the transfer quantity of electricity to compensate for the at least one of the change in or the inadequate value of the total electric voltage and/or the total electric frequency, as described above with respect to system 100 (FIG. 1). FIG. 6 illustrates a flow chart for an exemplary embodiment of procedure 502, according to an embodiment of method 500.

Referring now to FIG. 6, procedure 502 can comprise process 601 of increasing the transfer quantity of electricity being drawn from the at least one electric grid and being provided to the rechargeable energy storage system of the electric vehicle.

Referring again to FIG. 6, procedure 502 can comprise process 602 of decreasing the transfer quantity of electricity being drawn from the at least one electric grid and being provided to the rechargeable energy storage system of the electric vehicle. In some embodiments, the sequence of processes 601 and 602 can be reversed. Also, process 601 or 602 can be omitted.

Referring now back to FIG. 5, method 500 comprises procedure 503 of readjusting the transfer quantity of electricity being drawn from the at least one electric grid and being provided to the rechargeable energy storage system of the electric vehicle in order to provide either (a) that the rechargeable energy storage system of the electric vehicle receives a predetermined charge quantity of electricity or (b) that an average amount of electricity is provided to the rechargeable energy storage system of the electric vehicle over a duration of time, wherein the average amount of electricity is the transfer quantity of electricity pursuant to executing the one or more first computer instructions drawn from the at least one electric grid with the electric vehicle charging station. In many embodiments, procedure 503 can comprise readjusting the transfer quantity of electricity being drawn from the at least one electric grid and being provided to the rechargeable energy storage system of the electric vehicle only in order to provide that the rechargeable energy storage system of the electric vehicle receives a predetermined charge quantity of electricity (i.e., without providing that an average amount of electricity is provided to the rechargeable energy storage system of the electric vehicle over a duration of time). In some embodiments, when procedure 503 is performed to provide that the rechargeable energy storage system of the electric vehicle receives the predetermined charge quantity of electricity, procedure 503 can comprise readjusting the transfer quantity of electricity being provided to the rechargeable energy storage system of the electric vehicle to provide that the rechargeable energy storage system of the electric vehicle receives a predetermined charge quantity of electricity within a predetermined duration of time. Performing procedure 503 can be similar or identical to readjusting the transfer quantity of electricity to provide the rechargeable energy storage system with the predetermined charge quantity of electricity and/or the average amount of electricity, as described above with respect to system 100 (FIG. 1). In many embodiments, procedure 503 can be performed and/or can occur after procedure 502 is performed and/or occurs. FIG. 7 illustrates a flow chart for an exemplary embodiment of procedure 503, according to an embodiment of method 500.

Referring now to FIG. 7, procedure 503 can comprise process 701 of decreasing the transfer quantity of electricity being provided to the rechargeable energy storage system of the electric vehicle. In some embodiments, process 701 can be performed and/or can occur after process 601 (FIG. 6) is performed and/or occurs.

Referring again to FIG. 7, procedure 503 can comprise process 702 of increasing the transfer quantity of electricity being drawn from the at least one electric grid and being provided to the rechargeable energy storage system of the electric vehicle. In some embodiments, process 702 can be performed and/or can occur after process 602 (FIG. 6) is performed and/or occurs. Also, the sequence of processes 701 and 702 can be reversed regardless of the sequence of processes 601 and 602 (FIG. 6), and/or process 701 or 702 can be omitted.

Returning to FIG. 5, in various embodiments, procedures 502 and 503 can each be repeated one or more times. In some embodiments, procedure 502 can be performed and/or can occur more times than procedure 503, or vice versa. Accordingly, processes 601 (FIG. 6), 602 (FIG. 6), 701 (FIG. 7), and/or 702 (FIG. 7) can also be repeated one or more times and in any possible order, as applicable.

Method 500 in FIG. 5 can comprise procedure 504 of receiving a charge request to provide the predetermined charge quantity of electricity to the rechargeable energy storage system of the electric vehicle or to provide the average amount of electricity to the rechargeable energy storage system of the electric vehicle. In some embodiments, procedure 504 can comprise receiving a charge request only to provide the predetermined charge quantity of electricity to the rechargeable energy storage system of the electric vehicle. In some embodiments, the charge request can further comprise a time by which to provide the predetermined charge quantity of electricity. Procedure 504 can comprise receiving the charge request from a user of the electric vehicle charging station that desires to charge the rechargeable energy storage system of his or her electric vehicle. In many embodiments, procedure 504 can be performed and/or can occur prior to procedures 501-503. In various embodiments, procedure 504 can comprise receiving the charge request at the electric vehicle charging station or at a centralized computer system. The centralized computer system can be similar or identical to centralized computer system 108 (FIG. 1).

Referring again to FIG. 5, method 500 can comprise procedure 505 of determining the transfer quantity of electricity to be provided to the rechargeable energy storage system of the electric vehicle with the electric vehicle charging station. In some embodiments, procedure 505 can be performed and/or can occur after procedure 504 is performed and/or occurs. In the same or different embodiments, procedure 505 can be performed and/or can occur prior to or approximately simultaneously with procedure 501 being performed and/or occurring. In some embodiments, procedure 505 can comprise determining an average amount of electricity to be provided to the rechargeable energy storage system that will provide the predetermined charge quantity (e.g., as provided in the charge request) for a predetermined duration of time (e.g., as provided in the charge request).

Referring again to FIG. 5, method 500 can comprise procedure 506 of receiving a balance request to compensate for the at least one of the change in or the inadequate value of the total electric voltage and/or the total electric frequency. In some embodiments, procedure 506 can comprise receiving the balance request from an electricity supplier (e.g., utility company) at the electric vehicle charging station or at the centralized computer system.

Referring again to FIG. 5, method 500 can comprise procedure 507 of measuring the change in the total electric voltage and/or the total electric frequency. In some embodiments, when procedure 506 is performed and/or occurs, procedure 507 can be omitted, or vice versa.

In many embodiments, any of procedures 505-507 can be performed and/or can occur at the electric vehicle charging station or the centralized computer system. In some embodiments, one or more of procedures 505-507 can be performed and/or can occur at the electric vehicle charging station, and one or more of procedures 505-507 can be performed and/or can occur at the centralized computer system.

Referring again to FIG. 5, method 500 can comprise procedure 508 of receiving a measurement of the change in the total electric voltage and/or the total electric frequency. In some embodiments, procedure 508 can comprise receiving the measurement of the change in the total electric voltage and/or the total electric frequency from the electricity supplier. In other embodiments, when procedure 507 is performed and/or occurs at the centralized computer system, procedure 508 can comprise receiving the measurement of the change in the total electric voltage and/or the total electric frequency from the centralized computer system.

At least part of method 500 can be implemented via execution of computer instructions configured to run at one or more processing modules and configured to be stored at one or more memory storage modules. In some embodiments, the centralized computer system and/or a charging station computer can comprise the processing module(s) and/or the memory storage module(s). The charging station computer can be similar or identical to charging station computer 112 (FIG. 1).

FIG. 8 illustrates a flow chart for an embodiment of method 800 of balancing at least one electric grid. Method 800 is merely exemplary and is not limited to the embodiments presented herein. Method 800 can be employed in many different embodiments or examples not specifically depicted or described herein. In some embodiments, the procedures, the processes, and/or the activities of method 800 can be performed in the order presented. In other embodiments, the procedures, the processes, and/or the activities of the method 800 can be performed in any other suitable order. In still other embodiments, one or more of the procedures, the processes, and/or the activities in method 800 can be combined or skipped. In some embodiments, all or part of method 800 can be configured to operate in real time.

Referring now to FIG. 8, method 800 comprises procedure 801 of providing a transfer quantity of electricity from at least one electric grid to an electric vehicle charging station configured to provide the transfer quantity of electricity to a rechargeable energy storage system of an electric vehicle. The at least one electric grid can be similar or identical to electric grid 104 (FIG. 1), the electric vehicle charging station can be similar or identical to electric vehicle charging station 101 (FIG. 1), the rechargeable energy storage system can be similar or identical to rechargeable energy storage system 105 (FIG. 1), and/or the electric vehicle can be similar or identical to electric vehicle 106 (FIG. 1).

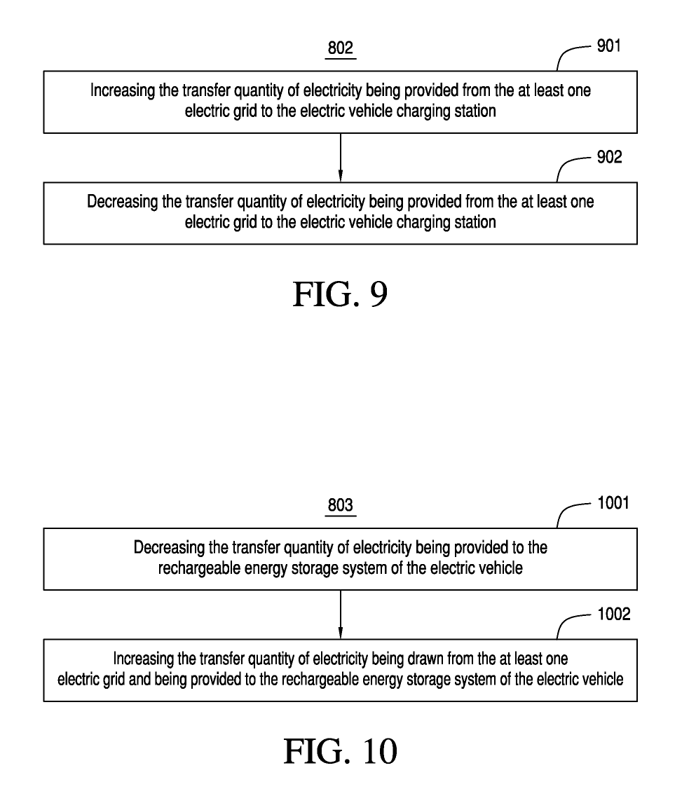

Referring again to FIG. 8, method 800 comprises procedure 802 of adjusting the transfer quantity of electricity being provided from the at least one electric grid to the electric vehicle charging station in order to compensate for at least one of a change in or an inadequate value of a demand for the total quantity of electricity. In some embodiments, procedure 802 can comprise adjusting the transfer quantity of electricity being provided from the at least one electric grid to the electric vehicle charging station in order to compensate for the at least one of the change in or the inadequate value of the total electric voltage and/or the total electric frequency. Performing procedure 802 can be similar or identical to adjusting the transfer quantity of electricity to compensate for the at least one of the change in and the inadequate value of the inadequate value of in a demand for the total quantity of electricity, as described above with respect to system 100 (FIG. 1). FIG. 9 illustrates a flow chart for an exemplary embodiment of procedure 802, according to an embodiment of method 800.

Referring now to FIG. 9, procedure 802 can comprise process 901 of increasing the transfer quantity of electricity being provided from the at least one electric grid to the electric vehicle charging station.

Referring again to FIG. 9, procedure 802 can comprise process 902 of decreasing the transfer quantity of electricity being provided from the at least one electric grid to the electric vehicle charging station. In some embodiments, the sequence of processes 901 and 902 can be reversed. Also, process 901 or 902 can be omitted.

Referring now back to FIG. 8, method 800 comprises procedure 803 of readjusting the transfer quantity of electricity being provided from the at least one electric grid to the electric vehicle charging station in order to satisfy a charge request for (a) a sufficient quantity of electricity to provide the rechargeable energy storage system of the electric vehicle with a charge quantity of electricity or (b) an average amount of electricity to be provided to the rechargeable energy storage system of the electric vehicle over a duration of time. In many embodiments, procedure 803 can comprise readjusting the transfer quantity of electricity being provided from the at least one electric grid to the electric vehicle charging station only in order to satisfy a charge request for a sufficient quantity of electricity to provide the rechargeable energy storage system of the electric vehicle with a charge quantity of electricity (i.e., without satisfying that an average amount of electricity be provided to the rechargeable energy storage system of the electric vehicle over a duration of time). In some embodiments, when procedure 803 is performed to provide the electric vehicle charging station with the sufficient quantity of electricity to satisfy that the rechargeable energy storage system of the electric vehicle receives the charge quantity of electricity, procedure 503 can comprise readjusting the transfer quantity of electricity being provided from the at least one electric grid to the electric vehicle charging station in order to satisfy a charge request for a sufficient quantity of electricity to provide the rechargeable energy storage system of the electric vehicle with a charge quantity of electricity within a predetermined duration of time. Performing procedure 803 can be similar or identical to readjusting the transfer quantity of electricity being provided from the at least one electric grid to the electric vehicle charging station in order to satisfy a charge request for a sufficient quantity of electricity to provide the rechargeable energy storage system of the electric vehicle with a charge quantity of electricity, as described above with respect to system 100 (FIG. 1). In some embodiments, procedure 803 can be performed and/or can occur after procedure 801 is performed and/or occurs. FIG. 10 illustrates a flow chart for an exemplary embodiment of procedure 803, according to an embodiment of method 800.

Referring now to FIG. 10, procedure 803 can comprise process 1001 of decreasing the transfer quantity of electricity being provided to the rechargeable energy storage system of the electric vehicle. In some embodiments, process 1001 can be performed and/or can occur after process 901 (FIG. 9) is performed and/or occurs.

Referring again to FIG. 10, procedure 803 can comprise process 1002 of increasing the transfer quantity of electricity being drawn from the at least one electric grid and being provided to the rechargeable energy storage system of the electric vehicle. In some embodiments, process 1002 can be performed and/or can occur after process 902 (FIG. 9) is performed and/or occurs. Also, the sequence of processes 1001 and 1002 can be reversed regardless of the sequence of processes 901 and 902 (FIG. 9), and/or process 1001 or 1002 can be omitted.

Returning now to FIG. 8, in various embodiments, procedures 802 and 803 can each be repeated one or more times. In some embodiments, procedure 802 can be performed and/or can occur more times than procedure 803, or vice versa. Accordingly, processes 901 (FIG. 9), 902 (FIG. 9), 1001 (FIG. 10), and/or 1002 (FIG. 10) can also be repeated one or more times and in any possible order, as applicable.

Referring now back to FIG. 8, method 800 can comprise procedure 804 of providing a balance request to at least one of a command module of the electric vehicle charging station or a centralized computer system configured to communicate with the electric vehicle charging station. The balance request can be a request to compensate for the at least one of the change in or the inadequate value of the demand for the total quantity of electricity (e.g., the change in the total electric voltage and/or the total electric frequency). The centralized computer system can be similar or identical to centralized computer system 108 (FIG. 1).

Referring again to FIG. 8, method 800 can comprise procedure 805 of measuring the change in the demand for the total quantity of electricity (e.g., the change in the total electric voltage and/or the total electric frequency). Procedure 805 can be performed and/or can occur at a location apart from the electric vehicle charging station and/or the centralized computer system.

Referring again to FIG. 8, method 800 can comprise procedure 806 of providing a measurement to at least one of the command module of the electric vehicle charging station or the centralized computer system configured to communicate with the electric vehicle charging station. The measurement can be a measurement of the change in the demand (e.g., as determined by procedure 805) for the total quantity of electricity (e.g., the change in the total electric voltage and/or the total electric frequency).

Referring again to FIG. 8, method 800 can comprise procedure 807 of calculating an original price (e.g., a standard price applied to consumers of electricity) for a primary quantity of electricity provided to the rechargeable energy storage system of the electric vehicle.

Referring again to FIG. 8, method 800 can comprise procedure 808 of calculating a discounted price (e.g., a special price applied to consumers of electricity that are providing electric load balancing for the at least one electric grid) for the primary quantity of electricity provided to the rechargeable energy storage system of the electric vehicle. The primary quantity of electricity can comprise the charge quantity of electricity, and the discounted price can be less than the original price.

At least part of method 800 can be implemented via execution of computer instructions configured to run at one or more processing modules and configured to be stored at one or more memory storage modules. In some embodiments, the centralized computer system and/or a charging station computer can comprise the processing module(s) and/or the memory storage module(s). The charging station computer can be similar or identical to charging station computer 112 (FIG. 1).

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 401-407 of FIG. 4, procedures 501-508 of FIG. 5, procedures 801-808 of FIG. 8, processes 601-602 of FIG. 6, processes 701-702 of FIG. 7, processes 901-902 of FIG. 9, and processes 1001-1002 of FIG. 10 may be comprised of many different procedures, processes, and activities and be performed by many different modules, in many different orders, that any element of FIGS. 1-10 may be modified, and that the foregoing discussion of certain of these embodiments does not necessarily represent a complete description of all possible embodiments. Furthermore, method 800 in FIG. 8 can include an additional procedure after procedure 807 and/or 808 of charging the original and/or discounted price to the user of the electric vehicle charging station.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A method for operating an electric vehicle charging station, at least part of the method being implemented via execution of computer instructions configured to run at one or more processing modules and configured to be stored at one or more memory storage modules, the method comprising:
executing one or more first computer instructions configured to draw a transfer quantity of electricity from at least one electric grid with the electric vehicle charging station to provide the transfer quantity of electricity to a rechargeable energy storage system of an electric vehicle, the rechargeable energy storage system being electrically coupled to the electric vehicle charging station, wherein the at least one electric grid comprises a total quantity of electricity, the total quantity of electricity comprises the transfer quantity of electricity, and the total quantity of electricity comprises a grid electric voltage and a grid electric frequency;
executing one or more second computer instructions configured to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency; and
after executing the one or more second computer instructions, executing one or more third computer instructions configured to readjust the transfer quantity of electricity being drawn from the at least one electric grid and being provided to the rechargeable energy storage system of the electric vehicle in order to provide the rechargeable energy storage system of the electric vehicle with a predetermined charge quantity of electricity;
wherein:
the computer instructions comprises the one or more first, second, and third computer instructions.

2) The method of claim 1 further comprising:
executing one or more fourth computer instructions configured to receive a charge request to provide the predetermined charge quantity of electricity to the rechargeable energy storage system of the electric vehicle.

3) The method of claim 2 further comprising:
executing one or more fifth computer instructions configured to determine the transfer quantity of electricity to be provided to the rechargeable energy storage system of the electric vehicle with the electric vehicle charging station;
wherein:
executing the one or more fifth computer instructions occurs after executing the one or more fourth computer instructions.

4) The method of claim 3 wherein:
executing the one or more fifth computer instructions occurs prior to or approximately simultaneously with executing the one or more first computer instructions.

5) The method of claim 1 further comprising:
executing one or more fourth computer instructions configured to receive a balance request to compensate for the at least one of the change in or the inadequate value of the at least one of the grid electric voltage or the grid electric frequency.

6) The method of claim 1 further comprising:
executing one or more fourth computer instructions configured to measure the change in the at least one of the grid electric voltage or the grid electric frequency.

7) The method of claim 1 further comprising:
executing one or more fourth computer instructions configured to receive a measurement of the change in the at least one of the grid electric voltage or the grid electric frequency.

8) The method of claim 1 wherein:
executing the one or more second computer instructions comprises executing one or more fourth computer instructions configured to increase the transfer quantity of electricity being drawn from the at least one electric grid and being provided to the rechargeable energy storage system of the electric vehicle.

9) The method of claim 8 wherein:
executing the one or more third computer instructions comprises:
after executing the one or more fourth computer instructions, executing one or more fifth computer instructions configured to decrease the transfer quantity of electricity being provided to the rechargeable energy storage system of the electric vehicle.

10) The method of claim 1 wherein:
executing the one or more second computer instructions comprises executing one or more fourth computer instructions configured to decrease the transfer quantity of electricity being drawn from the at least one electric grid and being provided to the rechargeable energy storage system of the electric vehicle.

11) The method of claim 10 wherein:
executing the one or more third computer instructions comprises:
after executing the one or more fourth computer instructions, executing one or more fifth computer instructions configured to increase the transfer quantity of electricity being drawn from the at least one electric grid and being provided to the rechargeable energy storage system of the electric vehicle.

12) The method of claim 1 wherein:
executing the one or more third computer instructions comprises:
after executing the one or more second instructions, executing one or more fourth computer instructions configured to readjust the transfer quantity of electricity being provided to the rechargeable energy storage system of the electric vehicle to provide that the rechargeable energy storage system of the electric vehicle receives a predetermined charge quantity of electricity within a predetermined duration of time.

13) A method of balancing at least one electric grid, at least part of the method being implemented via execution of computer instructions configured to run at one or more processing modules and configured to be stored at one or more memory storage modules, the method comprising:
executing one or more first computer instructions configured to provide a transfer quantity of electricity from at least one electric grid to an electric vehicle charging station configured to provide the transfer quantity of electricity to a rechargeable energy storage system of an electric vehicle, the rechargeable energy storage system being electrically coupled to the electric vehicle charging station, wherein the at least one electric grid comprises a total quantity of electricity, and the total quantity of electricity comprises the transfer quantity of electricity;
executing one or more second computer instructions configured to adjust the transfer quantity of electricity being provided from the at least one electric grid to the electric vehicle charging station in order to compensate for at least one of a change in or an unsuitable amount of a demand for the total quantity of electricity; and
after executing the one or more second computer instructions, executing one or more third computer instructions configured to readjust the transfer quantity of electricity being provided from the at least one electric grid to the electric vehicle charging station in order to satisfy a charge request for a sufficient quantity of electricity to provide the rechargeable energy storage system of the electric vehicle with a charge quantity of electricity;
wherein:
the computer instructions comprises the one or more first, second, and third computer instructions.

14) The method of claim 13 further comprising:
executing one or more fourth computer instructions configured to provide a balance request to at least one of: (1) a command module of the electric vehicle charging station, or (2) a centralized computer system configured to communicate with the electric vehicle charging station;
wherein:
the balance request is to compensate for the least one of the change in or the unsuitable amount of the demand for the total quantity of electricity.

15) The method of claim 13 further comprising:
executing one or more fourth computer instructions configured to measure the change in the demand for the total quantity of electricity.

16) The method of claim 13 further comprising:
executing one or more fourth computer instructions configured to provide a measurement to at least one of: (1) a command module of the electric vehicle charging station or (2) a centralized computer system configured to communicate with the electric vehicle charging station, the measurement being a measurement of the change in the demand for the total quantity of electricity.

17) The method of claim 13 wherein:
executing the one or more second computer instructions comprises executing one or more fourth computer instructions configured to increase the transfer quantity of electricity being provided from the at least one electric grid to the electric vehicle charging station.

18) The method of claim 17 wherein:
executing the one or more third computer instructions comprises:
after executing the one or more fourth computer instructions, executing one or more fifth computer instructions configured to decrease the transfer quantity of electricity being provided from the at least one electric grid to the electric vehicle charging station.

19) The method of claim 13 wherein:
executing the one or more second computer instructions comprises executing one or more fourth computer instructions configured to decrease the transfer quantity of electricity being provided from the at least one electric grid to the electric vehicle charging station.

20) The method of claim 19 wherein:
executing the one or more third computer instructions comprises:
after executing the one or more fourth computer instructions, executing one or more fifth computer instructions configured to increase the transfer quantity of electricity being provided from the at least one electric grid to the electric vehicle charging station after executing the one or more second computer instructions.

21) The method of claim 13 further comprising:
executing one or more fourth computer instructions configured to calculate an original price for a primary quantity of electricity provided to the rechargeable energy storage system of the electric vehicle; and
executing one or more fifth computer instructions configured to calculate a discounted price for the primary quantity of electricity provided to the rechargeable energy storage system of the electric vehicle;
wherein:
the primary quantity of electricity comprises the charge quantity of electricity; and
the discounted price is less than the original price.

22) A system comprising:
an electric vehicle charging station comprising:
a charge module configured to draw a transfer quantity of electricity from at least one electric grid and to provide the transfer quantity of electricity to a rechargeable energy storage system of an electric vehicle, the rechargeable energy storage system being configured to be electrically coupled to the electric vehicle charging station; and
a command module;
wherein:
the at least one electric grid comprises a total quantity of electricity, the total quantity of electricity comprises the transfer quantity of electricity, and the total quantity of electricity comprises a grid electric voltage and a grid electric frequency;
the command module is configured to instruct the charge module to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency; and
after instructing the charge module to adjust the transfer quantity of electricity, the command module is configured to instruct the charge module to readjust the transfer quantity of electricity being drawn from the at least one electric grid and being provided to the rechargeable energy storage system of the electric vehicle in order to provide that the rechargeable energy storage system of the electric vehicle receives a charge quantity of electricity.

23) The system of claim 22 further comprising:
a communication module configured to receive a request to compensate for the at least one of the change in or the inadequate value of the at least one of the grid electric voltage or the grid electric frequency and to communicate the request to the command module.

24) The system of claim 23 wherein:
the communication module is configured to receive a measurement of the change in the at least one of the grid electric voltage or the grid electric frequency and to communicate the measurement to the command module.

25) The system of claim 23 wherein:
the electric vehicle charging station comprises the communication module.

26) The system of claim 23 further comprising:
a centralized computer system configured to communicate with the electric vehicle charging station;
wherein:
the centralized computer system comprises the communication module.

27) The system of claim 22 wherein:
the command module comprises a decision module configured to determine whether the charge module is able to adjust the transfer quantity of electricity being drawn from the at least one electric grid and being provided to the rechargeable energy storage system of the electric vehicle in order to compensate for the at least one of the change in or the inadequate value of the at least one of the grid electric voltage or the grid electric frequency while remaining able to readjust the transfer quantity of electricity being drawn from the at least one electric grid and being provided to the rechargeable energy storage system of the electric vehicle in order to provide that the rechargeable energy storage system of the electric vehicle receives the charge quantity of electricity.

28) The system of claim 22 further comprising:
a measurement module configured to measure the change in the at least one of the grid electric voltage or the grid electric frequency.

29) The system of claim 28 wherein:
the command module comprises the measurement module.

30) The system of claim 22 further comprising:
a calculation module configured to at least one of: (a) calculate a first amount of electricity by which to adjust the transfer quantity of electricity being drawn from the at least one electric grid and being provided to the rechargeable energy storage system of the electric vehicle in order to compensate for the at least one of the change in or the inadequate value of the at least one of the grid electric voltage or the grid electric frequency or (b) after the command module instructs the charge module to adjust the transfer quantity of electricity, calculate a second amount of electricity by which to readjust the transfer quantity of electricity being drawn from the at least one electric grid and being provided to the rechargeable energy storage system of the electric vehicle in order to provide that the rechargeable energy storage system of the electric vehicle receives the charge quantity of electricity.

31) The system of claim 30 wherein:
the command module comprises the calculation module.

32) The system of claim 22 further comprising:
the electric vehicle;
wherein:
the rechargeable energy storage system is electrically coupled to the electric vehicle charging station.

33) A method of providing a system, the method comprising:
providing a charge module of an electric vehicle charging station, the charge module being configured to draw a transfer quantity of electricity from at least one electric grid and to provide the transfer quantity of electricity to a rechargeable energy storage system of an electric vehicle, the rechargeable energy storage system being configured to electrically couple to the electric vehicle charging station; and
providing a command module of the electric vehicle charging station;
wherein:
the at least one electric grid comprises a total quantity of electricity, the total quantity of electricity comprises the transfer quantity of electricity, and the total quantity of electricity comprise a grid electric voltage and a grid electric frequency;
the command module is configured to instruct the charge module to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency; and
after instructing the charge module to adjust the transfer quantity of electricity, the command module is configured to instruct the charge module to readjust the transfer quantity of electricity being drawn from the at least one electric grid and being provided to the rechargeable energy storage system of the electric vehicle in order to provide that the rechargeable energy storage system of the electric vehicle receives a charge quantity of electricity.

34) The method of claim 33 further comprising:
providing the electric vehicle charging station;
wherein:
providing the electric vehicle charging station comprises:
providing the charge module; and
providing the command module.

35) The method of claim 33 further comprising:
providing a communication module configured to receive a request to compensate for the at least one of the change in or the inadequate value of the at least one of the grid electric voltage or the grid electric frequency and to communicate the request to the command module.

36) The method of claim 35 wherein:
providing the electric vehicle charging station comprises providing the communication module.

37) The method of claim 35 further comprising:
providing a centralized computer system configured to communicate with the electric vehicle charging station;
wherein:
providing the centralized computer system comprises providing the communication module.

38) The method of claim 33 further comprising:
providing a decision module configured to determine whether the charge module is able to adjust the transfer quantity of electricity being drawn from the at least one electric grid and being provided to the rechargeable energy storage system of the electric vehicle in order to compensate for the at least one of the change in or the inadequate value of the at least one of the grid electric voltage or the grid electric frequency while remaining able to readjust the transfer quantity of electricity being drawn from the at least one electric grid and being provided to the rechargeable energy storage system of the electric vehicle in order to provide that the rechargeable energy storage system of the electric vehicle receives the charge quantity of electricity.

39) The method of claim 33 further comprising:
providing a measurement module configured to measure the change in the at least one of the grid electric voltage or the grid electric frequency.

40) The method of claim 39 wherein:
providing the command module comprises providing the measurement module.

41) The method of claim 33 further comprising:
providing a calculation module configured to at least one of: (a) calculate a first amount of electricity by which to adjust the transfer quantity of electricity being drawn from the at least one electric grid and being provided to the rechargeable energy storage system of the electric vehicle in order to compensate for the at least one of the change in or the inadequate value of the at least one of the grid electric voltage or the grid electric frequency or (b) after the command module instructs the charge module to adjust the transfer quantity of electricity, calculate a second amount of electricity by which to readjust the transfer quantity of electricity being drawn from the at least one electric grid and being provided to the rechargeable energy storage system of the electric vehicle in order to provide that the rechargeable energy storage system of the electric vehicle receives the charge quantity of electricity.

42) The method of claim 41 wherein:
providing the command module comprises providing the calculation module.

43) A method for operating an electric vehicle charging station, at least part of the method being implemented via execution of computer instructions configured to run at one or more processing modules and configured to be stored at one or more memory storage modules, the method comprising:
executing one or more first computer instructions configured to draw a transfer quantity of electricity from at least one electric grid with the electric vehicle charging station to provide the transfer quantity of electricity to a rechargeable energy storage system of an electric vehicle electrically coupled to the electric vehicle charging station, wherein the at least one electric grid comprises a total quantity of electricity, the total quantity of electricity comprises the transfer quantity of electricity, and the total quantity of electricity comprises a grid electric voltage and a grid electric frequency;
executing one or more second computer instructions configured to adjust the transfer quantity of electricity being drawn from the at least one electric grid and being provided to the rechargeable energy storage system of the electric vehicle in order to compensate for at least one of a change in or an inadequate value of at least one of the grid electric voltage or the grid electric frequency; and
after executing the one or more second computer instructions, executing one or more third computer instructions configured to readjust the transfer quantity of electricity being drawn from the at least one electric grid and being provided to the rechargeable energy storage system of the electric vehicle in order to provide either (a) that the rechargeable energy storage system of the electric vehicle receives a predetermined charge quantity of electricity or (b) that an average amount of electricity is provided to the rechargeable energy storage system of the electric vehicle over a duration of time, wherein the average amount of electricity is the transfer quantity of electricity pursuant to executing the one or more first computer instructions drawn from the at least one electric grid with the electric vehicle charging station;
wherein:
the computer instructions comprises the one or more first, second, and third computer instructions.

44) The method of claim 43 further comprising:
executing one or more fourth computer instructions configured to determine the transfer quantity of electricity to be drawn from the at least one electric grid with the electric vehicle charging station upon executing the one or more first computer instructions based on at least one of the average amount of electricity or the duration of time.
